(19) United States
(12) Patent Application Publication
(10) Pub. No.: US 2005/0034339 A1
(43) Pub. Date: Feb. 17, 2005

(54) Shadowbox greeting cards

(76) Inventor: Paula Kay Schmidt Adkins, Spring Lake, MI (US)

Correspondence Address: Paula Adkins, 14928 Minetta Ave, Spring Lake, MI, 49456, US

(21) Appl. No.: 10/641,451

(22) Filed: Aug. 16, 2003

(51) Int. Cl. G09F 1/00

(52) U.S. Cl. 40/124.09; 40/743

(57) ABSTRACT

An original 8.5×11 cardstock paper transformed into a shadowbox. The shadowbox in the assembled position will have a middle viewing section combined with the frame section which will include printed matter that provides a 3D viewing image scene.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Not Applicable

### BRIEF SUMMARY OF THE INVENTION

A greeting card that can be unfolded and put together as a shadowbox with diecuts, scores, removable adhesive strip, clear rubber sticky adhesive and 8½×11 cardstock. The card can be placed on any structure for viewing a printed design with a 3D effect. The card can have professionally printed matter for this 3D effect such as: graphic design, text, landscapes, animals, structures, graphics, etc.

The card could be used for blank purposes, for example, constructive and teacher use such as: crafts and school projects.

The card can also be available in many different sizes to meet specific means such as: regular size greeting cards, photo cards (a plastic pocket for picture insertions), small note cards, or any blank size shadowbox card for advertising purposes such as: menus, placecards, or signage.

### BRIEF DESCRIPTION OF THE SEVERAL VIEWS OF THE DRAWINGS

FIG. 1 8.5×11 Layout shown where the diecuts, scores and removable adhesive will be.

FIG. 2 Shadowbox shown folded with a 3D effect.

FIG. 3 8.5×11 Layout shown larger with crop marks, diecuts, and 1-4 directions on how to fold the card into a Shadowbox.

FIG. 4 Shadowbox shown larger folded with a 3D effect.

FIG. 5 Right view shown as folded Shadowbox Greeting Card

FIG. 6 Left view shown as folded Shadowbox Greeting Card

FIG. 7 Perspective view shown as folded Shadowbox Greeting Card

FIG. 8 Shadowbox Greeting Card shown folded for storage and mailing purposes in a standard size envelope. Also 2 clear rubber sticky adhesives in which should removed from the card. This will ensure the card to stay flat for folding and mailing.

Additional Examples of others Sizes and Uses.

### DETAILED DESCRIPTION OF THE INVENTION OR DESCRIPTION OF THE PREFERRED EMBODIMENT

This invention is not as complex as it may seem. For example, using an 8½ by 11 size of a heavy cardstock paper and transmitting it into a shadowbox. This is a new way of viewing, sending, and storing greeting cards; rather that the original greeting cards that does a standard open-fold either horizontal or vertical.

This process would have to be professionally done with specific diecuts, scores, and with 2 types of removable adhesive for it to work properly. It can then be inserted into and envelope.

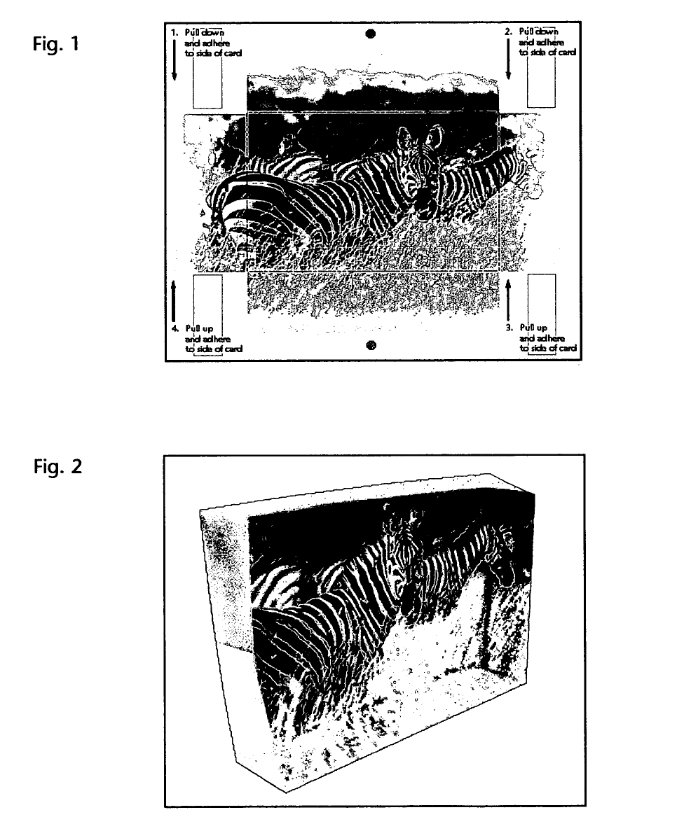

I have the dimensions that will make this happen. See FIG. 1 The process will have to done by a printing company and/or manufacturer with the proper equipment to enable every function of the card. I know as a graphic designer, all of these functions can be done by printers and manufacturers.

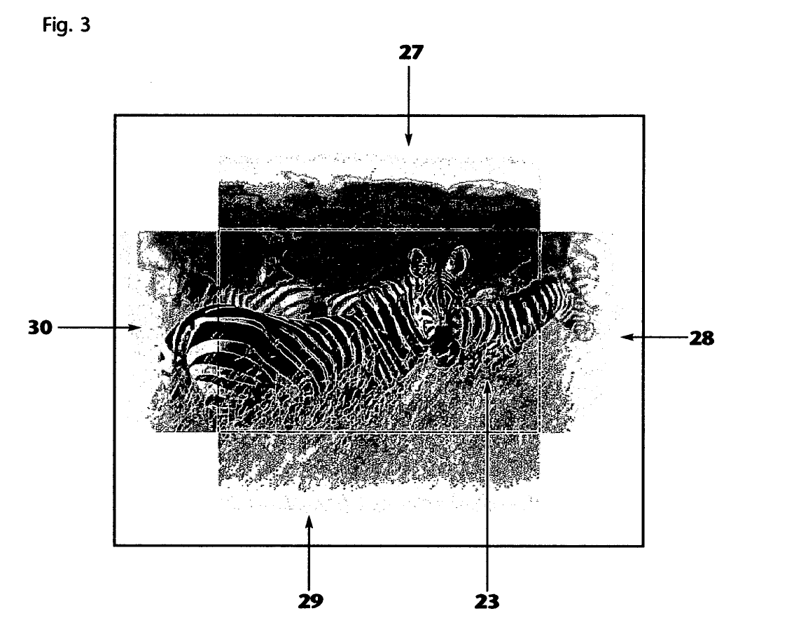

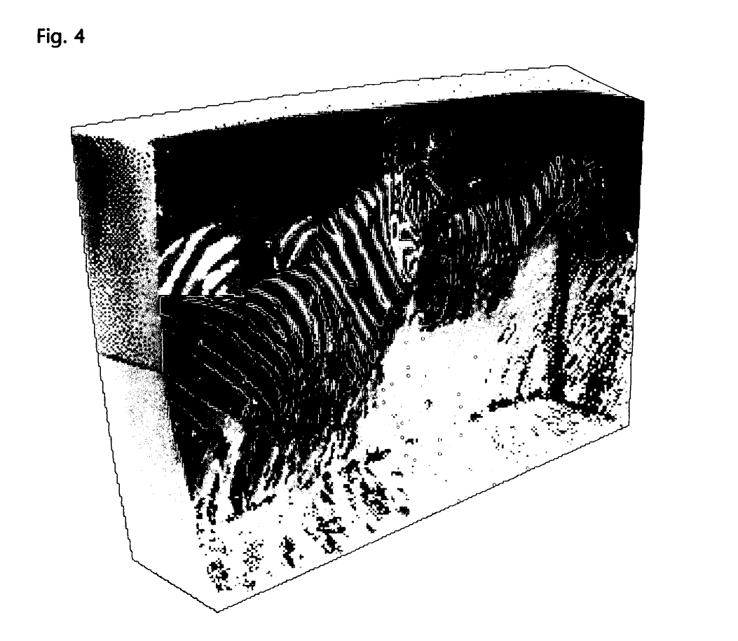

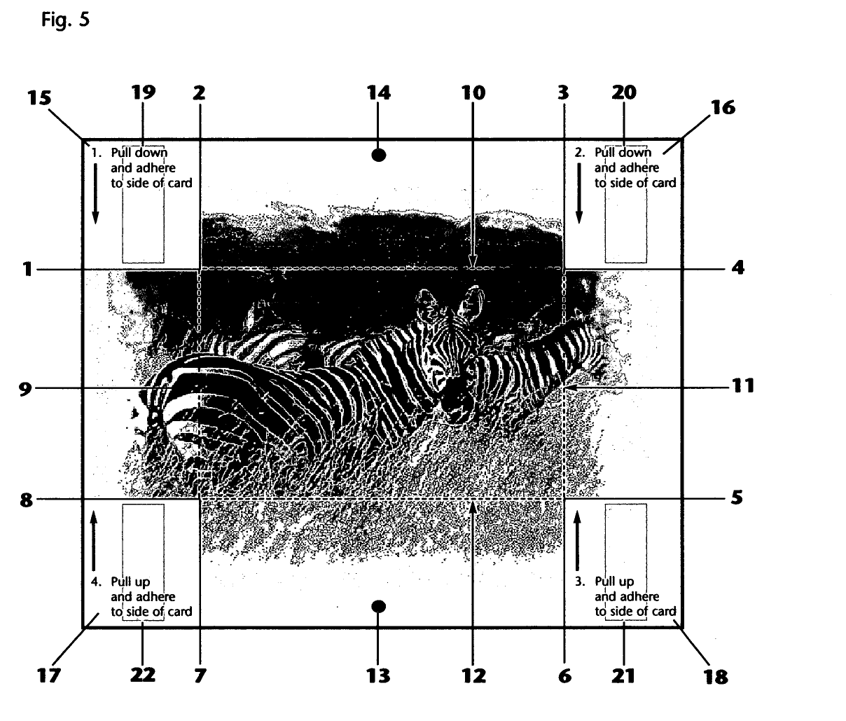

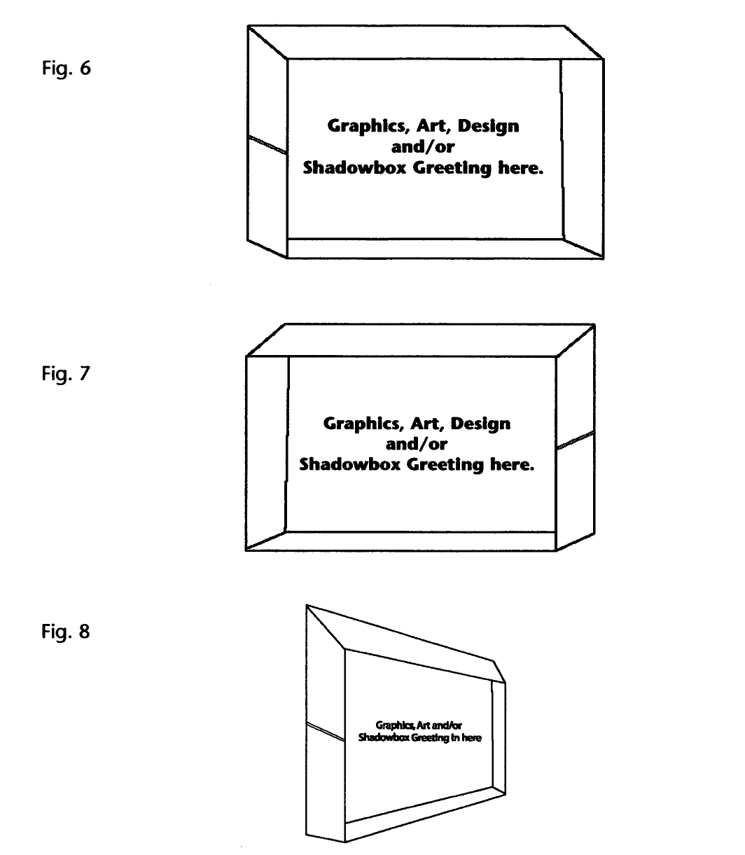

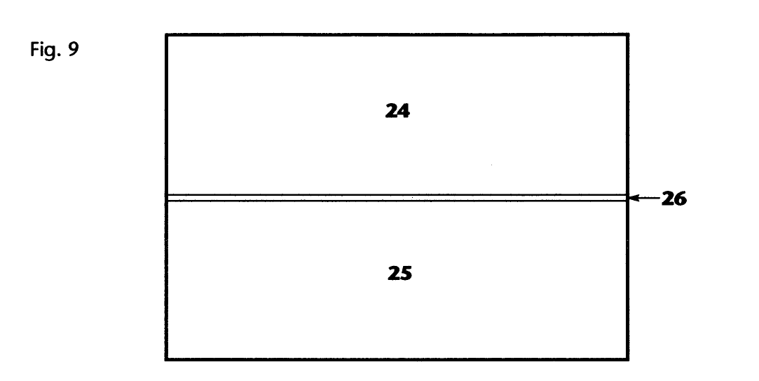

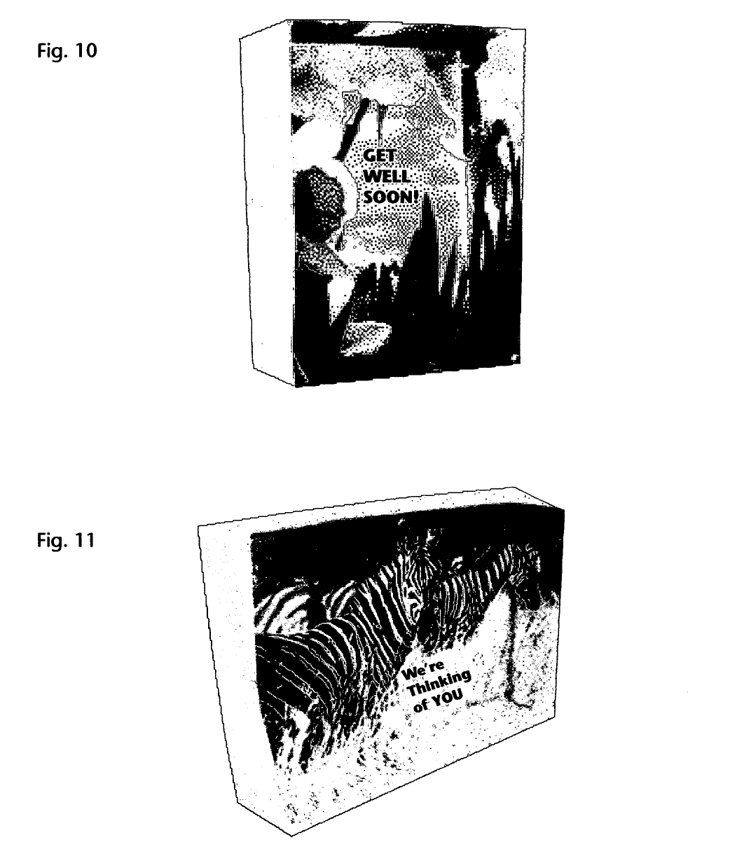

There will be directions on the card so it will be simple to put together. It will be in only 4 simple steps which will be pull down and pull up and stick to side of card. See FIG. 3

This improvement is an exciting and creative way for a greeting card, therefore, I believe many people will be very open and accepting to this idea.

Sequence Listing

Not Applicable

1. What I claim as my invention is Shadowbox Greeting Cards, which is a greeting card that can be folded into a shadowbox for viewing a 3D effect. It can be folded, unfolded, and put together as a shadowbox with diecuts, scores, removable adhesive strip, clear rubber sticky adhesive and 8½×11 cardstock (or any size that will permit). There will be directions on the card so it will be simple to put together. It will be in only 4 simple steps which will be pull down and pull up and stick to side of card. The card can have professionally printed matter for this 3D effect such as: graphic design, text, landscapes, animals, structures, and advertising purposes. It can also be used blank for schools and craft project. All of the functions of the card is my claim for Shadowbox Greeting Cards, in order for it to work properly I would need all of these named functions.
